(19) United States
(12) Patent Application Publication
(10) Pub. No.: US 2026/0244482 A1
(43) Pub. Date: Aug. 20, 2026

(54) PROCESSING-IN-MEMORY (PIM) ARCHITECTURE SUPPORTING MULTIPLE CONTEXTS WITH EFFICIENT CONTEXT SWITCHING

(71) Applicant: QUALCOMM Incorporated, San Diego, CA (US)

(72) Inventors: Subbarao Palacharla, San Diego, CA (US); Pan Deng, San Diego, CA (US); Rui Cao, San Diego, CA (US); Pankaj Deshmukh, San Diego, CA (US); Jungwon Suh, San Diego, CA (US)

(21) Appl. No.: 19/058,643

(22) Filed: Feb. 20, 2025

(51) Int. Cl. G06F 9/46; G06F 15/78

(52) U.S. Cl. CPC G06F 9/461; G06F 15/7807

(57) ABSTRACT

Systems, methods, devices, and apparatuses are disclosed for supporting and efficiently switching between multiple contexts associated with multiple system-on-a-chip (SoC) clients in a processing-in-memory (PIM) architecture. An example method performed by a memory controller of a PIM device includes: initiating execution of a first task on a first virtual PIM hosted by a first SoC client; receiving, after interrupting the execution of the first task based on a context switching protocol, a first PIM context for the first task; saving the first PIM context to a memory bank of the PIM device; and, after completion of a second task on a second virtual PIM hosted by a second SoC client, restoring, using the first PIM context saved to the memory bank, execution of the first task on the first virtual PIM.

### TECHNICAL FIELD

This disclosure relates generally to processing-in-memory (PIM) architectures, and more specifically, to PIM architectures supporting multiple contexts with efficient context switching.

### BACKGROUND

Modern computing systems increasingly handle large-scale matrix computations, particularly in artificial intelligence (AI) applications such as Large Language Models (LLMs). These computations often require significant memory bandwidth and computational resources. Processing-in-memory (PIM) architectures have emerged as a solution to address the memory bandwidth bottleneck by performing computations closer to where data resides. In PIM architectures, computational units (also referred to herein as “PIM units”) are integrated within memory devices, such as Dynamic Random Access Memory (DRAM), to enable matrix-vector operations to be performed directly within the memory device. This approach can leverage higher memory bandwidth that is available inside the DRAM device compared to traditional architectures, i.e., where data must be transferred between memory and processor.

A PIM unit may be used to support one or more tasks of an application and maintain contexts for the one or more tasks. A context may include a set of data loaded into one or more registers for a task in order to indicate the state of the task. PIM units in DRAMs typically support a single or otherwise limited hardware for contexts to minimize area overhead on cost-sensitive DRAM dies. For example, a single hardware for a context (referred to herein as “hardware context”) may include a vector register, one or more multiplication accumulation (MAC) units, and an accumulator register.

However, AI and other computationally expansive applications running on these hardware resource constrained PIM devices present unique challenges. For example, such applications are increasingly relying on heterogenous computing. In heterogenous computing, tasks for applications such as AI are distributed over multiple computing cores and/or subsystems, such as but not limited to a central processing units (CPUs), graphic processing units (GPUs), neural signal processors (NSP), as part of one or more systems-on-chips SoCs. Sharing the limited hardware context of a PIM device across these multiple computing cores and/or subsystems (e.g., CPU, GPU, NSP, etc.) (referred to herein as “SoC clients”) for AI and other applications can often lead to functional errors during the execution of tasks for these applications. Such functional errors can include but are not limited to incorrect data write of contexts into a shared register and/or incorrect reading of contexts from the shared register due to tasks between two SoC clients occurring simultaneously.

There is thus a desire and need for a better system for supporting multiple tasks and contexts across multiple SoC clients, as characteristic of heterogenous computing, using a PIM architecture. There is also a desire and need for an efficient way to share the limited hardware resources (e.g., DRAM) within a PIM across SoC clients. Furthermore, there is a desire and need to prevent and/or reduce the aforementioned functional errors through a better system and method for switching between tasks and/or contexts using the PIM architecture.

Various embodiments of the present disclosure address one or more of the aforementioned shortcomings.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes systems, methods, devices, and apparatuses for supporting multiple contexts (e.g., including efficiently switching between the multiple contexts) associated with multiple system-on-a-chip (SoC) clients in a processing-in-memory (PIM) architecture. Aspects of the subject matter described in this disclosure can be implemented in a processing-in-memory (PIM) device. The PIM device may include a memory (e.g., DRAM) storing one or more registers, such as but not limited to a vector register, a multiplication accumulation (MAC) register, and an accumulator register for use as hardware for storing contexts (the registers referred to collectively as “hardware contexts”). A context may include a set of data loaded into one or more registers for a task in order to indicate the state of the task. A memory controller may operate on the memory and may interface with a plurality of SoC clients, such as but not limited to a CPU, a GPU, or an NSP. In various embodiments, each SoC client may be assigned a task to perform. The tasks may be part of a larger application and may be distributed across the SoC clients, such as, for example, in a heterogenous computing architectures used for artificial intelligence applications. The memory controller may support the use of the limited hardware context in the PIM device by interfacing with virtual PIMs hosted in the respective SoC clients (e.g., a virtual CPU PIM, a virtual GPU PIM, a virtual NSP PIM, etc.). In some embodiments, the memory controller may generate or facilitate the generation of these respective virtual PIMs in each of the SoC clients.

Furthermore, the memory controller may enable the efficient switching between multiple contexts and/or tasks associated with the contexts using the limited hardware resources of the PIM device, in a manner that avoids or reduces functional errors. For example, in various embodiments, a task (first task) being performed or executed by a virtual PIM of a SoC client (first virtual PIM of a first SoC client) may be interrupted based on a context switching protocol. The memory controller may facilitate the context associated with the task (first context) to be saved to the hardware context (e.g., a set of registers) on the memory (e.g., DRAM) of the PIM device. A virtual PIM of another SoC client (second virtual PIM of a second SOC client) may begin performance or execution of another task (second task). After the completion of the second task, or after an interruption of the second task prompting the first task to be resumed (e.g., based on the context switching protocol), the memory controller may cause the first virtual PIM (of the first SoC client) to resume operation of the first task through a load and restore operation, where the first virtual PIM may restore the first context from the set of registers of the memory of the PIM device. The use of context saving and context loading and/or restoring by the memory controller on virtual PIMs hosted by SoC clients may facilitate the efficient switching between multiple contexts and/or tasks using the limited hardware resources of the PIM device.

In one aspect of the disclosure, a method for supporting multiple contexts in a PIM device associated with multiple SoC clients includes: initiating, by a memory controller of the PIM device, execution of a first task on a first virtual PIM hosted by a first SOC client of the plurality of SOC clients; receiving, by the memory controller based on an interruption of the execution of the first task, a first PIM context associated with the interrupted execution of the first task; saving, by the memory controller, the first PIM context associated with the interrupted execution of the first task to a memory bank of the PIM device; and restoring, by the memory controller using the first PIM context saved to the memory bank, execution of the first task on the first virtual PIM.

In an additional aspect of the disclosure, an apparatus is disclosed for supporting multiple contexts using a PIM device. The apparatus includes: a memory comprising one or more registers and configured to store PIM contexts; and a memory controller coupled to the memory, and configured to perform operations comprising: initiating execution of a first task on a first virtual PIM hosted by a first SOC client of a plurality of SOC clients; receiving, based on an interruption of the execution of the first task, a first PIM context associated with the interrupted execution of the first task; saving the first PIM context associated with the interrupted execution of the first task to the memory; and restoring, using the first PIM context saved to the memory, execution of the first task on the first virtual PIM.

In an additional aspect of the disclosure, a system for supporting multiple contexts in a PIM device is disclosed. The system includes: a plurality of system on a chip (SOC) clients. Each SOC client is configured to host a respective virtual PIM. The plurality of SOC clients includes at least a first SOC client hosting a first virtual PIM and a second SOC client hosting a second virtual PIM. The system further includes a memory including one or more registers and configured to store PIM contexts; and a memory controller coupled to the memory, and configured to perform operations including: receiving a plurality of tasks including a first task and a second task; initiating execution of the first task on the first virtual PIM; interrupting the execution of the first task based on a context switching protocol for switching between tasks of the plurality of tasks; saving a first PIM context associated with the interrupted execution of the first task to the memory by reading the first PIM context from a first register of the one or more registers; initiating execution of the second task on the second virtual PIM; saving a second PIM context associated with a completed execution of the second task to the memory by reading the second PIM context from a second register of the one or more registers; and restoring, using the first PIM context saved to the memory, the execution of the first task on the first virtual PIM.

In an additional aspect of the disclosure, a non-transitory computer-readable medium stores instructions that, when executed by a processor, cause the processor to perform operations. The operations include: initiating, by a memory controller of the PIM device, execution of a first task on a first virtual PIM hosted by a first SOC client of the plurality of SOC clients; receiving, by the memory controller based on an interruption of the execution of the first task, a first PIM context associated with the interrupted execution of the first task; saving, by the memory controller, the first PIM context associated with the interrupted execution of the first task to a memory bank of the PIM device; and restoring, by the memory controller using the first PIM context saved to the memory bank, execution of the first task on the first virtual PIM.

These and other implementations may each optionally include one or more of the following features. For instance, various implementations may include one or more of: parallel processing capabilities, different memory configurations, various block sizes, different bit-width combinations, and different scaling factor arrangements.

The various aspects, implementations, and features disclosed herein may be implemented in a variety of ways. For example, aspects may be implemented as a device, such as a processing-in-memory device, a memory controller, or an integrated circuit. Aspects may also be implemented as one or more methods or processes. Further, aspects may be implemented as instructions stored in a computer-readable storage medium that, when executed by one or more processors, cause the processors to perform the disclosed operations. Such computer-readable storage media may include, but are not limited to, random access memory (RAM), read-only memory (ROM), electrically erasable programmable read-only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium capable of storing instructions for execution by processors.

The various aspects may also be implemented in hardware, software, firmware, or any combination thereof. For instance, aspects may be implemented as dedicated circuits or logic configured to execute the described functionality. Alternatively or additionally, aspects may be implemented as programs, modules, routines, or other software components executed by one or more processors. In some implementations, aspects may be implemented using application-specific integrated circuits (ASICs), field-programmable gate arrays (FPGAs), or other programmable logic devices.

The details of one or more implementations are set forth in the accompanying drawings and description below. Other features and advantages will be apparent from the description and drawings, and from the claims. It is to be understood that both the foregoing general description and the following detailed description are exemplary and explanatory only and are not restrictive of the invention, as claimed. Features shown in the various figures can be combined and/or modified in ways not explicitly shown, while remaining within the scope of the claims.

### DESCRIPTION OF THE FIGURES

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a processing-in-memory system that can be configured for supporting and efficiently switching between multiple contexts associated with multiple system on a chip (SoC) clients according to one or more aspects of this disclosure.

FIG. 2A shows a block diagram illustrating a basic PIM DRAM architecture that can support matrix-vector multiplication and block quantization according to one or more aspects of this disclosure.

FIG. 2B shows an operational flow diagram illustrating matrix-vector multiplication processes within the PIM DRAM architecture according to one or more aspects of this disclosure.

FIG. 3A shows an operational flow diagram illustrating how a PIM device supports multiple contexts associated with multiple SoC clients according to one or more aspects of this disclosure.

FIG. 3B shows an operational flow diagram illustrating how a PIM device efficiently switches between multiple contexts associated with multiple SoC clients according to one or more aspects of this disclosure.

FIG. 4 shows a flow chart of an example method performed by a PIM device for supporting multiple contexts by efficiently saving and restoring contexts according to one or more aspects of this disclosure.

FIG. 5 shows a flow chart of an example method performed by a PIM device for supporting and efficiently switching between multiple contexts associated with multiple SoC clients according to one or more aspects of this disclosure.

FIG. 6 shows a block diagram of an example PIM device configured to support multiple contexts associated with multiple SoC clients according to one or more aspects of this disclosure.

Like reference numbers and designations in the various drawings indicate like elements.

### DETAILED DESCRIPTION

The present disclosure provides systems, apparatus, methods, and computer-readable media that support improved processing-in-memory operations, such as techniques for supporting and efficiently switching between multiple contexts associated with multiple system on a chip (SoC) clients.

Shortcomings of previous techniques mentioned here are only representative and are included to highlight problems that the inventors have identified with respect to existing processing-in-memory devices and sought to improve upon. AI and other heterogenous computing applications running on PIM devices present unique challenges, as the tasks for such applications are typically distributed over multiple system-on-chip (SoC) clients (e.g., CPU, GPU, NSP, etc.). The PIM device has a limited hardware context to support the multiple contexts for these multiple tasks distributed among the SoC clients. The sharing of this limited hardware context (e.g., a set of registers) in the memory of the PIM device to perform the various tasks across the multiple SoC clients can often lead to functional errors during the execution of these tasks. There is thus a desire and need for a better systems, methods, devices, and apparatuses for supporting multiple tasks and contexts across multiple SoC clients and for efficiently switching between tasks and/or contexts using the shared PIM architecture. Aspects of devices described below may address some or all of these shortcomings as well as others known in the art. Aspects of the improved devices described herein may present other benefits than, and be used in other applications than, those described above.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, memory devices, and processes to provide a thorough understanding of the present disclosure. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a processing-in-memory device.

Aspects of the disclosure involve techniques for supporting and efficiently switching between multiple tasks and contexts associated with multiple SoC clients in a processing-in memory (PIM) architecture. The PIM architecture may involve a PIM device that includes a memory. In some aspects, the PIM device may further include a memory controller operating on the memory and interfacing with the multiple SoC clients. In other aspects, the memory controller may be separate from the PIM device. The memory (e.g., a DRAM, an SRAM, etc.) may include one or more registers (e.g., a vector register, an accumulator register, a multiplication accumulation (MAC) unit, etc.) for processing and storing each of the multiple contexts. The memory controller may support the multiple tasks and contexts associated with the multiple SoC clients by facilitating the hosting of a virtual PIM in each of the multiple SoC clients (e.g., a virtual CPU PIM for the CPU, a virtual GPU PIM for the GPU, a virtual NSP PIM for the NSP, etc.). In some embodiments, the memory controller may generate or facilitate the generation of these respective virtual PIMs in each of the SoC clients. The virtual PIMS may allow the sharing of the limited hardware resources of the PIM device (e.g., the set of registers) across the SoC clients as if each SoC client had a private PIM dedicated to that client. For example, an SoC client, through its virtual PIM, may suspend a task by saving a context for the task into the set of registers in the PIM device via the virtual PIM of the SoC client. The SoC client may then (e.g., at a subsequent point) restore execution of the task by loading the context from the set of registers in the PIM device via the virtual PIM of the SoC client.

Implementations involve various aspects that enable the efficient switching between multiple contexts and/or tasks associated with the contexts using the limited hardware resources of the PIM device, in a manner that avoids or reduces functional errors. For example, in various embodiments, a memory controller may receive a plurality of tasks (e.g., for an AI application utilizing heterogenous computing), and may assign each task among multiple SoC clients. A task (first task) being performed or executed by a virtual PIM (first virtual PIM) of an SoC client (a first SoC client) may be interrupted based on a context switching protocol. The context switching protocol, which may be received by the memory controller, may be based on, for example, a time associated with an execution of a task exceeding a predetermined time threshold and/or a size of data associated with the task exceeding a predetermined size threshold (e.g., thus prompting, for each scenario, a switching to another task). Also or alternatively, the context switching protocol may be based on a priority of a task relative to other tasks (e.g., of the heterogenous computing application) or a priority of the SoC client assigned to the task, relative to other SoC clients.

Based on the interruption of the first task, the memory controller may facilitate the saving of the context associated with the first task (first context) into the set of registers in the memory (e.g., DRAM) of the PIM device. A virtual PIM (second virtual PIM) of another SoC client (a second SoC client) may begin performance or execution of another task (second task). After the completion of the second task, or after an interruption of the second task prompting the first task to be resumed (e.g., based on the context switching protocol), the memory controller may cause the first virtual PIM of the first SoC client to resume operation of the first task through a load and restore operation, where the first virtual PIM can restore the first context from the set of registers of the memory of the PIM device. The use of context saving and context restoring by the memory controller on virtual PIMs hosted by SoC clients may facilitate the efficient switching between multiple contexts and/or tasks using the limited hardware resources of the PIM device.

In some embodiments, the PIM device may include multiple sets of registers (also referred to as “context banks” or “hardware contexts”) for use in multiple contexts to minimize transfer of vector and/or accumulator values. The multiple context banks inside the PIM device may further facilitate the efficient interleaving between multiple SoC clients running the multiple tasks and workloads associated with heterogeneous computing of AI and other applications.

Particular implementations of the subject matter described in this disclosure may be implemented to realize one or more of the following potential advantages or benefits. In some aspects, the present disclosure provides techniques for more efficient processing of heterogenous computing applications across multiple SoC clients in processing-in-memory operations. By allocating efficient switching between the multiple tasks and contexts through the use of saving and restoring contexts in the shared memory of the PIM device, the techniques lead to reduction or avoidance of functional errors in the processing of tasks and contexts. Furthermore, the use of virtual PIMs to interface with the memory controller, the limited hardware of the PIM device is able to more effectively support the multiple SoC clients, and therefore lead to greater optimization of PIM architecture and greater scalability in heterogenous computing. Furthermore, the use of PIM architecture in the implementations allow for the processing of computationally expansive applications, like AI, with significantly reduced memory requirements thereby, making such applications feasible on mobile and resource-constrained devices. The foregoing features combine to create a highly efficient processing environment within the PIM device.

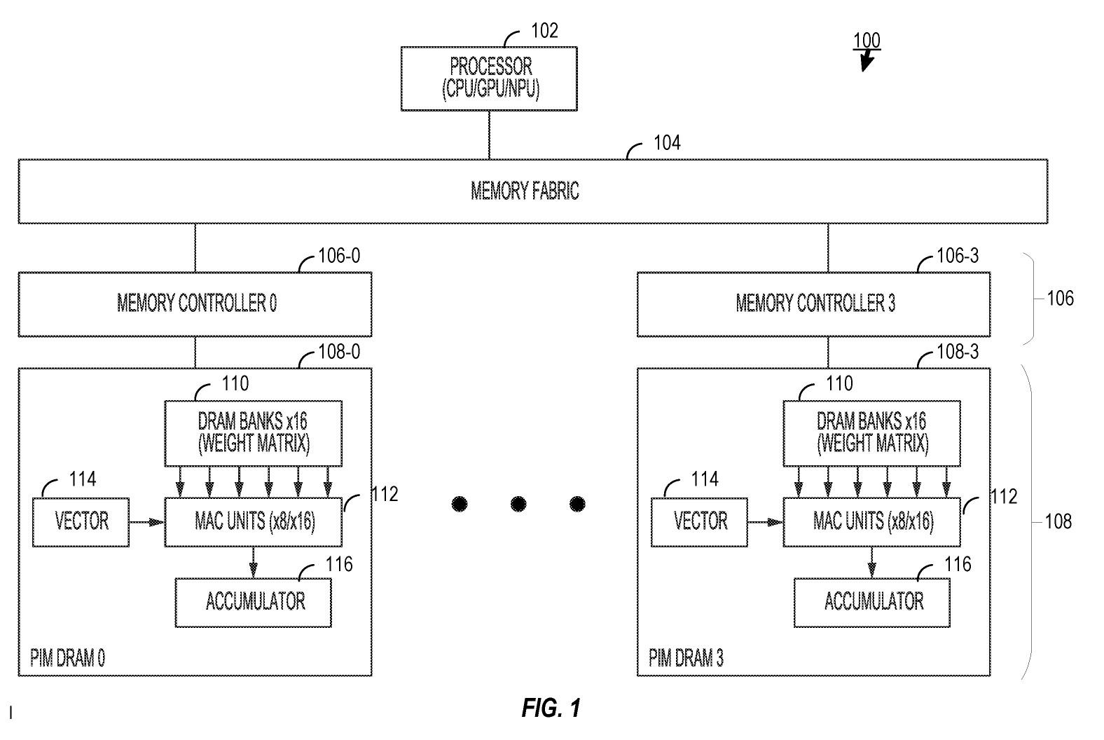

FIG. 1 is a block diagram of a processing-in-memory system that can be configured for supporting and efficiently switching between multiple contexts associated with multiple SoC clients according to aspects described herein. System 100 include one or more processors or processor cores 102 associated with the multiple SoC clients. The one or more processors 102 may be used in machine learning (ML), AI, and/or other computationally intensive applications, and may be implemented using various processing architectures. For example, the one or more processors 102 may include but are not limited to a central processing unit (CPU), graphics processing unit (GPU), neural processing unit (NPU), application-specific integrated circuit (ASIC), or combinations thereof. The one or more processor 102 can be configured to manage high-level operations, distribute computational tasks (e.g., further among other processors and/or SoC clients), and coordinate processing across memory devices.

A memory fabric 104 couples to the one or more processors 102 and enables data movement and processing capabilities. Memory fabric 104 can be specialized to support various processing-in-memory operations through command handling, routing protocols, and synchronization mechanisms. The fabric 104 may implement different interconnect technologies and topologies depending on system requirements, including point-to-point connections, crossbar switches, or mesh networks.

Memory fabric 104 connects to one or more multiple memory controllers 106 (illustrated as memory controllers 106-0 through 106-3 in one implementation, though other quantities may be implemented). Each memory controller 106 can be configured to support processing-in-memory commands and operations beyond traditional memory access patterns. Furthermore, each memory controller 106 may perform operations on the memory 108 and may interface with the one or more processors 102 corresponding to one or more SoC clients (e.g., compute subsystems). Memory controllers 106 may implement specialized command queues, reordering logic, and timing control to manage both conventional memory operations and processing-in-memory functions. Furthermore, each memory controller 106 may implement context loading and context restoring operations into the memory 108, for contexts associated with various tasks performed by the one or more processors 102. Different implementations may employ varying numbers of controllers based on factors such as system size, bandwidth requirements, and power constraints.

Each memory controller 106 couples to a corresponding memory 108 in the PIM device. As shown in FIG. 1, an example of such memory 108 may be a processing-in-memory DRAM (PIM DRAM) device, and the PIM DRAM is being shown and referenced for ease of explanation. However, though other memory devices for PIM are also contemplated (e.g., PIM SRAM) and can be substituted for PIM DRAM where applicable. While four PIM DRAM devices (108-0 through 108-3) for the memory are shown, systems may scale from single devices to large arrays of devices. Each PIM DRAM 108 includes multiple DRAM banks 110, which may be implemented in various configurations (for example, eight, sixteen, or thirty-two banks per device). The DRAM banks 110 can be configured to store different types of data, such as but not limited to weight matrices for neural network computations, activation values, or general computational data structures. DRAM Banks 110 may be organized into different zones or regions optimized for specific access patterns or computational requirements.

Within each PIM DRAM 108, multiply-accumulate (MAC) units 112 couple to DRAM banks 110 and can be configured to perform various computational operations, e.g., from basic multiplication and accumulation to more complex functions. The number and capability of MAC units 112 may vary by implementation, with configurations ranging from four to thirty-two units being common examples. MAC units 112 can support multiple precision formats (for example, 4-bit, 8-bit, 16-bit operations) and various operational modes, including Single Instruction Multiple Data (SIMD) execution where a single command triggers parallel execution across all units within a device.

Vector interfaces 114 (also referred to herein as “vectors” or “vector registers”) provide input paths for vector data into MAC units 112. These interfaces can support different data widths and formats, enabling flexible handling of input vectors. Vector accumulators 116 (also referred to herein as “accumulators” or accumulator registers”) couple to MAC units 112 in each PIM DRAM 108 and can be configured with varying bit widths and accumulation depths based on application requirements.

The system supports sophisticated execution models across different hierarchical levels. Within each PIM DRAM 108, SIMD execution enables efficient parallel processing across MAC units. Across different PIM DRAM devices 108, Multiple Instruction Multiple Data (MIMD) execution allows independent operations to proceed in parallel, which are managed through software orchestration via spawn and synchronization mechanisms controlled by ML processor 102.

Memory controllers 106 implement complex coordination mechanisms to manage both traditional memory access as well as processing-in-memory operations. This can include specialized command scheduling, resource allocation, and synchronization across multiple devices. The architecture enables significant bandwidth improvements compared to traditional approaches by minimizing data movement between memory and processing units. In operation, system 100 can handle heterogeneous and/or diverse computational workloads by distributing operations among multiple SoC clients (via their respective processors and/or processor cores 102), and, in some embodiments, among multiple PIM DRAM devices 108. Furthermore, the system 100 can support the multiple contexts associated with multiple workloads distributed among the multiple SoC clients by having the memory controller 106 facilitate and/or interface with virtual PIMs hosted by respective SoC clients. Even further, the system 100 can efficiently and effectively interleave the multiple workloads performed by the multiple SoC clients by having the memory controller 106 efficiently load contexts associated with these workloads into the PIM DRAM devices 108, and restore contexts from the PIM DRAM device to the virtual PIMs as needed. Data structures may be partitioned and distributed across DRAM banks 110 in various ways depending on application requirements. The architecture supports different scaling approaches, from small embedded systems to large computational arrays, while maintaining the benefit of performing computations close to data storage.

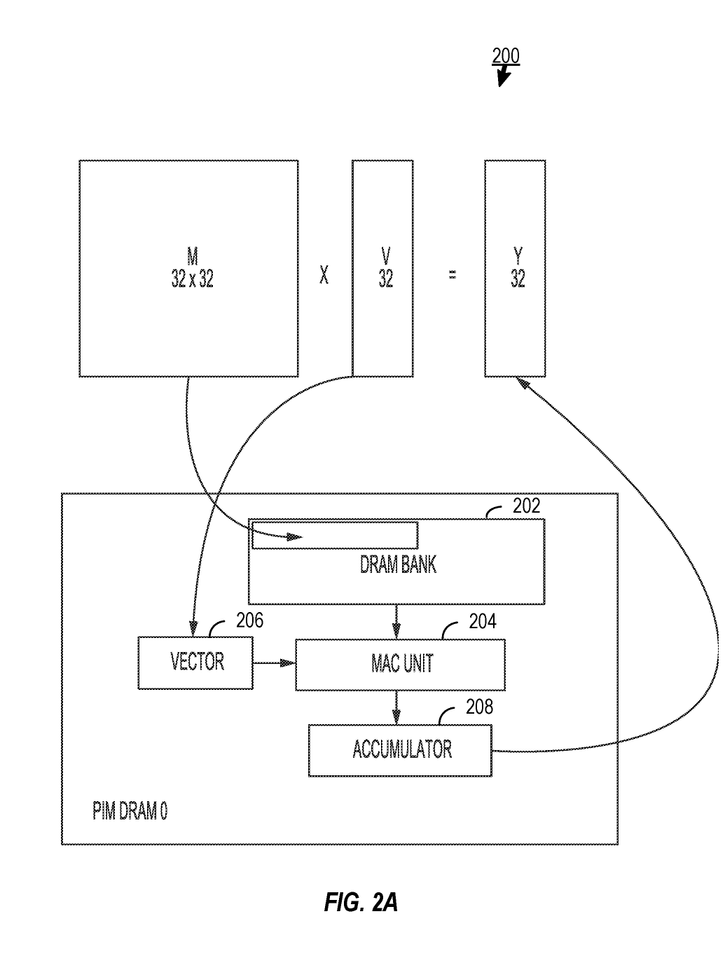

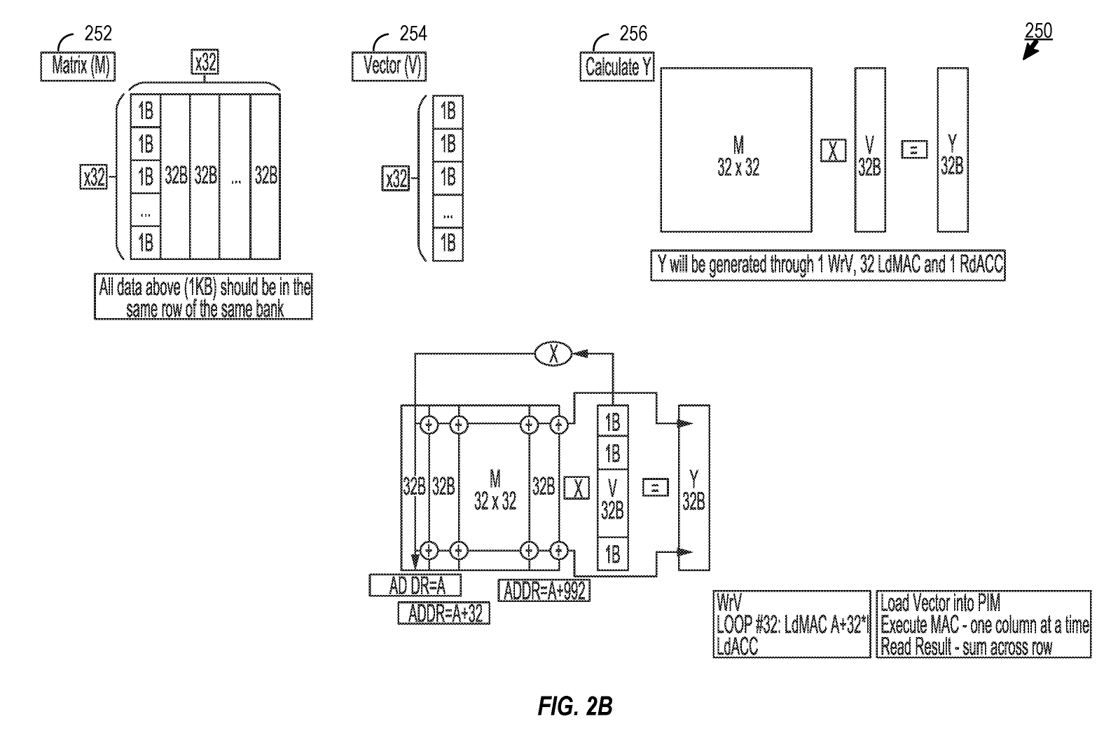

FIGS. 2A and 2B illustrate processing-in-memory operation fundamentals that can support efficient matrix computations, including supporting and efficiently switching between multiple contexts associated with multiple SoC clients, according to aspects described herein. FIG. 2A shows a basic PIM DRAM architecture 200 while FIG. 2B illustrates the corresponding operational flow 250 of matrix-vector multiplication within the architecture.

Referring to FIG. 2A, a PIM DRAM architecture 200 can include a DRAM bank 202 configurable to store matrix data, such as neural network weight matrices. In mobile or resource-constrained systems, these weights may be stored in reduced precision formats, such as 4-bit values, to minimize memory footprint. A MAC unit 204 can couple to DRAM bank 202 and may process matrix values along with vector inputs. Vector register 206 can provide storage for input vectors and may couple to MAC unit 204. An accumulator 208 can couple to MAC unit 204 and may store operation results.

FIG. 2B details the operational flow 250 of matrix-vector multiplication within architecture 200. A weight matrix M 252 can be arranged as a 32 x 32 matrix occupying, for example, 1 kilobyte of memory in DRAM bank 202, though other sizes and arrangements may be implemented. An input vector V 254 may comprise 32 elements stored in vector register 206, with the size being configurable based on implementation requirements. The multiplication operation produces a result vector Y 256 that can be stored in accumulator 208.

The operational sequence can begin with a Write Vector (WrV) operation that loads input data into vector register 206. After activating the appropriate DRAM page, the system can perform a series of Load and MAC (LdMAC) operations, processing one matrix column at a time through MAC unit 204. Results may accumulate in accumulator 208 and can be accessed through Load Accumulator (LdACC) operations.

Implementation of the PIM architecture 200, as shown in FIG. 2A and 2B, can support multiple contexts associated with the multiple tasks being performed by multiple SoC clients for the heterogenous application of AI/ML models (e.g., large language models) and the like. For example, the DRAM bank 202 can store multiple contexts associated with the multiple tasks being assigned to the multiple SOC clients for the performance of the heterogenous application. Furthermore, the system 200 may support sets of registers for each SoC client. Each set may include, for example, the vector register 206 and the accumulator register 208 working with the MAC unit 204. Even further, a given SoC client may execute their assigned task and save contexts for the task to their assigned set of registers via a virtual PIM hosted by the SoC client. For example, when an SoC client saves the context to the virtual PIM may cause the memory controller to save the context to the physical set of registers in the PIM DRAM. The given SoC client may also be able to resume operations for their task by loading, via the virtual PIM, the context for the task. For example, based on the load command, a memory controller may restore the task on the virtual PIM by loading context data saved on the set of registers physically located in the PIM DRAM or saved in the memory bank (e.g., DRAM bank 202).

These and other implementations can build upon the architecture and operational flow illustrated in FIGS. 2A and 2B, with various implementations possible depending on system requirements and constraints.

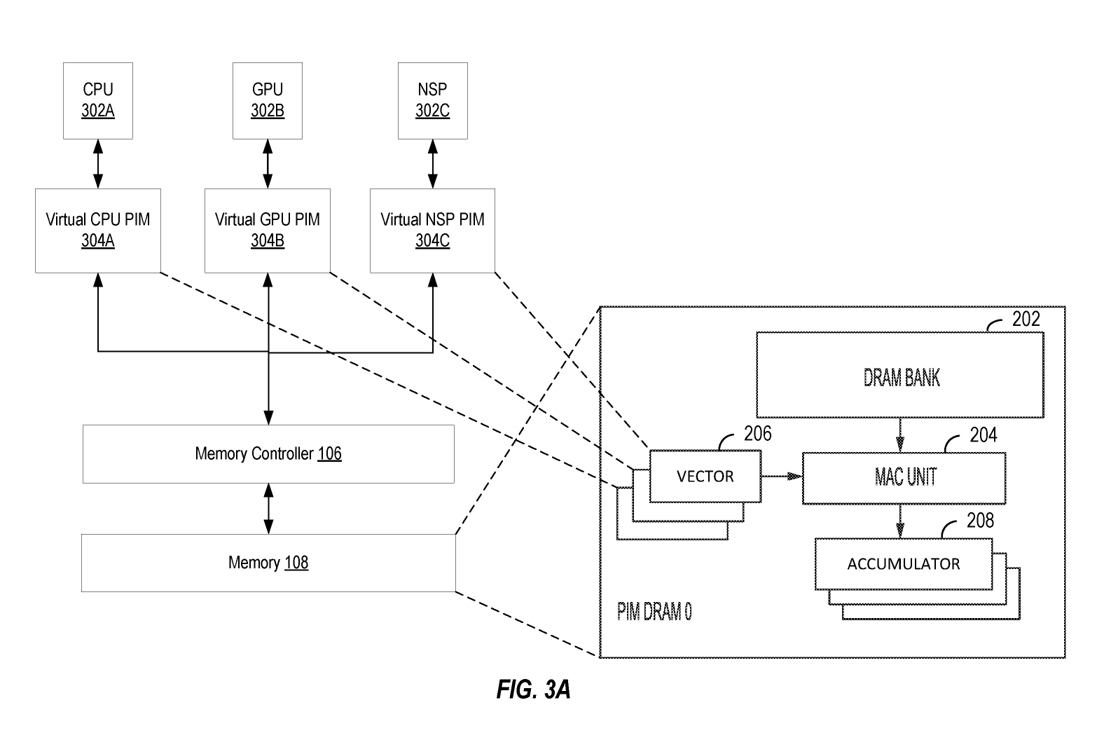

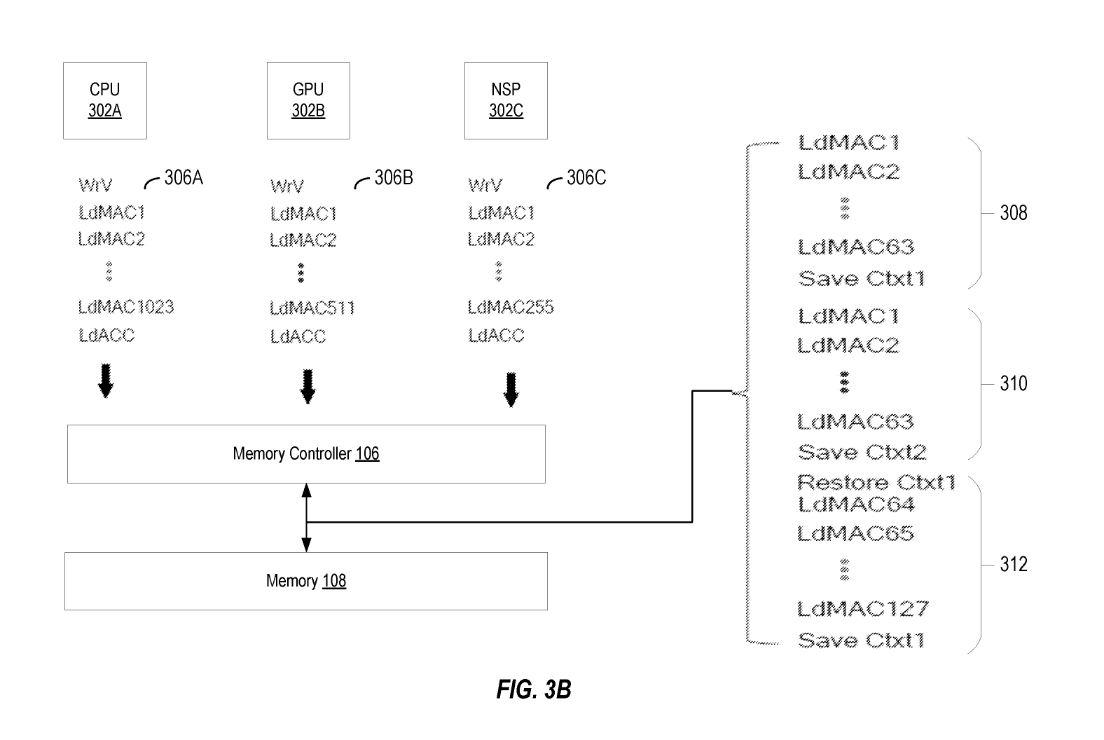

FIG. 3A shows an operational flow diagram illustrating how a PIM device supports multiple contexts associated with multiple SoC clients according to one or more aspects of this disclosure. As previously discussed, AI and other computationally expansive applications increasingly rely on heterogenous computing, where application tasks are distributed over a plurality of cores and compute subsystems in one or more SoCs, such cores and compute subsystems being referred to herein as SoC clients. For example, as shown in FIG. 3A, such SoC clients may include but are not limited to a CPU 302A, a GPU 302B, and an NSP 302C. As previously discussed, heterogenous computing can present issues for conventional PIM architectures, as PIM typically relies on the use of limited hardware resources of an underlying device (PIM device), sometimes only a single set of registers. Even if such limited hardware resource is shared, there is a need for a mechanism or technique by which SoC clients can perform their respective tasks for a heterogenous application (e.g., heterogenous AI application) efficiently and in a manner that reduces functional errors.

The present disclosure describes various embodiments for supporting multiple contexts and tasks associated with multiple SoC clients using the PIM device, and efficiently switching between these multiple contexts and tasks. For example, the limited hardware resources of the PIM device may be rendered accessible and/or otherwise utilizable for multiple contexts or tasks through virtualization. As shown in FIG. 3A, a memory controller 106 may cause, or facilitate each SoC client to host a virtual PIM, such as virtual CPI PIM 304A, a virtual GPU PIM 304B, and a virtual NSP PIM 304C for the CPU 302A, GPU 302B, and NSP 302C, respectively. Each virtual PIM may include an abstraction of (e.g., a mapping of) the set of registers in the memory 108 to allow the SoC client to manage and utilize the set of registers of the memory 108 more flexibly in the completion of a task assigned to the SoC client. For example, the virtual PIM may include a virtual set of registers (e.g., a virtual vector register, a virtual accumulator, etc.). In some embodiments, the memory controller 106 may generate or aid in the generation of the virtual PIM for each SoC client. Furthermore, each virtual PIM may allow the SoC client to perform its assigned tasks as if the physical PIM resources of the memory 108 were dedicated to the SoC client. By allowing the SoC client to perform its assigned tasks virtually via the respective virtual PIM, the limited physical PIM resources of the memory 108 of the PIM device can thus be rendered more accessible (e.g., for use by other SoC clients) and/or otherwise usable by other SoC clients for other tasks and/or contexts. Access to the actual physical PIM resources may be arbitrated or controlled by the memory controller 106.

In some embodiments, limited hardware resources of the PIM device may be configured, modified, and/or optimized to support the multiple contexts. In at least one embodiment, the modification or optimization may involve assigning each SoC client a set of registers. For example, as shown in FIG. 3A, the memory 108 of the PIM device, shown here as a PIM DRAM, may comprise the DRAM bank 202, one or more vector registers 206, one or more MAC units 204, and one or more accumulator registers 208, components described previously in relation to FIGS. 1-2B. The combination of these registers may be used to efficiently generate matrix vector computations. The modification or optimization of the memory 108 may involve having a set of vector registers 206, each vector register 206 being assigned to a specific SoC client. Additionally, or alternatively, the modification or optimization of the memory 108 may involve having a set of accumulator registers 208, each accumulator register 208 being assigned to the specific SoC client. Thus, each SoC client may have its own set of registers, including a vector register 206 and an accumulator register 208.

Additionally, or alternatively, the modification or optimization may involve reusing the physical set of registers for the multiple contexts. Given that these set of registers may be used to process and store a context for an SoC client, the ability to reuse the set of registers for multiple contexts (e.g., from multiple SoC clients 302A-C) may be performed by having the multiple SoC clients 302A-C process and store the contexts on respective virtual PIMS 304A-C, and having the memory controller 106 use the context values stored on the virtual PIMs 304A-C to save the context to the memory 108 itself. For example, the memory controller 106 may save the context to a physical register when it is available. Additionally, or alternatively, the memory controller 106 may save the context to a separate storage device (e.g., DRAM bank 202) that may serve as a context bank. The memory controller 106 may retrieve a context from the context bank to load on to a register (e.g., when the register is available again for use).

In some embodiments, the PIM device may have a single set of registers shared among the SoC clients. For example, after a context is saved to the set of registers via a virtual PIM of one SoC client, the memory controller 106 may store the values for the context saved to the set of registers in the separate storage (e.g., the DRAM bank 202), to allow the set of registers to be reused (e.g., to save another context from another SoC client to the set of registers). When the memory controller 106 is prompted by a virtual PIM to restore a context, the memory controller 106 may retrieve values associated for the context from the separate storage (e.g., DRAM bank 202) and reload those values to the physical set of registers. The memory controller 106 and/or the virtual PIM may then restore the context to allow the virtual PIM to resume a task associated with the context. In this manner, the PIM device may be able to support multiple contexts even with a single set of registers.

FIG. 3B shows an operational flow diagram illustrating how a PIM device can efficiently switch between multiple contexts associated with multiple SoC clients according to one or more aspects of this disclosure. As previously discussed, running multiple contexts within a PIM architecture can lead to functional errors. For example, if the multiple contexts were to include a first context associated with a task performed by a first SoC client, and a second context associated with a task performed by a second SoC client, switching from the first context to the second context may lead to the following functional error. A virtual PIM associated with the first SoC client (first virtual PIM) may begin writing vector values to a vector register and then may begin loading vector values to a MAC unit (e.g., for each column of a matrix). However, before the loaded values are able to be stored in an accumulator register, another virtual PIM (second virtual PIM) associated with the second SoC client may begin writing vector values to a vector register. However, the MAC unit or may perform a wrong calculation for the first virtual PIM based on previously entered values being overwritten into the vector register by the second virtual PIM. The lack of synchronization may lead to erroneous computations for context storage and, as a result, functional errors in the application. Furthermore, if switching between tasks were to be avoided, then the completion of an entirety of a task by each SoC client before another task could be initiated would lead to slower application processes and reduce user experience and quality of service. FIG. 3B thus shows an example embodiment for how the PIM device can efficiently switch between the multiple contexts to avoid such functional errors.

As shown in FIG. 3B, multiple SoC clients (e.g., CPU 302A, GPU 302B, and NSP 302C) may each be assigned a task, for example, as part of an AI application utilizing a heterogenous computing framework. A sequence of commands for each task is shown and may be performed by each SoC client (e.g., commands 306A assigned to be performed by CPU 302A, commands 306B assigned to be performed by GPU 302B, and commands 306C assigned to be performed by NSP 302C). The commands may be performed using the virtual PIMs hosted by the respective SOC clients. The memory controller 106 may then save contexts associated with each task (e.g., as written in the respective virtual PIM by each respective SoC client) into the memory 108 (e.g., in a physical register and/or in another storage (e.g., DRAM bank 202)).

The memory controller 106 may facilitate the interleaving of multiple tasks and contexts as shown on the right hand side. For example, the memory controller 106 may cause the CPU 302A to initiate execution of its task 306A, for which the CPU 302A may begin writing values into a vector register (“WrV). The values may then be loaded into one or more MAC units 204 (e.g., in a repetitive process based on a number of matrix columns) The loading of values into the MAC units 204 is shown via the LdMAC command in FIG. 3B, and involves a series of commands from LdMAC1 through LdMAC1023. However, as shown in section 308 on the right hand side, the CPU 302A may be interrupted during its execution of its task after entering the commands LdMAC63. The interruption may be prompted by a context switching protocol. The memory controller may then save a context for the task that the CPU 302A has yet to complete, as shown by the command Save Ctxt1. Based on the command, the memory controller 106 may store the context for the current progress of the task 306A of CPU 302A on to the memory 108 (e.g., in a physical register and/or a separate storage (e.g., DRAM bank 202).

The context switching protocol and/or the interruption may be based on any reason or number of reasons as may be appropriate for an application or device. In some embodiments, some SoC clients and/or their associated tasks may be given more priority over other SoC clients and/or their associated tasks, depending on the nature of the application or the computing device. For example, the memory controller 106 may receive a high priority task and may subsequently assign it to an SoC client for immediate execution, prompting the suspension of an ongoing task of another SoC client. Additionally, or alternatively, tasks being executed may have predetermined time limits or data limits, so that they do not unnecessarily delay or serve as a bottleneck for the competition of other tasks that may be quicker to process.

For any of the aforementioned reasons and/or based on a context switching protocol, the memory controller 106 may facilitate the initiation of another task (second task 306B) assigned to the GPU 302B. Thus, as shown in FIG. 3B, the series of commands for the second task 306B may include, after having loaded values to a vector (WrV), the loading values to the MAC units in a series of commands from LdMAC1 through LdMAC511. The GPU 302B may thus enter commands (e.g., via the virtual PIM) to load values into the MAC units from LdMAC1 through LdMAC63 before the task is interrupted by the memory controller 106 to return to the previous task 306A. As before, the GPU 302B may enter a command (e.g., via an associated virtual PIM) to save the context associated with the incomplete second task 306B (Save Ctxt2). Based on the command, the memory controller 106 may store the context for the current progress of the task 306B of GPU 302B on to the memory 108 (e.g., in a physical register and/or a separate storage (e.g., DRAM bank 202). In some embodiments, saving the context may involve the memory controller 106 taking accumulated values based on the entered commands storing the values (e.g., in an accumulator register 208 assigned to the CPU 302A and/or in a context bank stored in DRAM bank 202).

Furthermore, the memory controller 106 may restore the first task 306A (e.g., via the command Restore Ctxt1 as shown), enabling the CPU 302A to resume operation of the first task. For example, the restoring may include the memory controller 106 retrieving the context for the first task from the memory 108 (e.g., a physical register or the DRAM bank 202). In some embodiments, the memory controller 106 may further load the retrieved context on to the virtual PIM of the CPU 302A to facilitate the resuming of the first task. By configuring the memory controller to save and restore contexts for multiple tasks, by interfacing with virtual PIMs of SOC clients assigned with the multiple tasks, the memory controller may efficiently switch and/or interleave between multiple contexts and tasks.

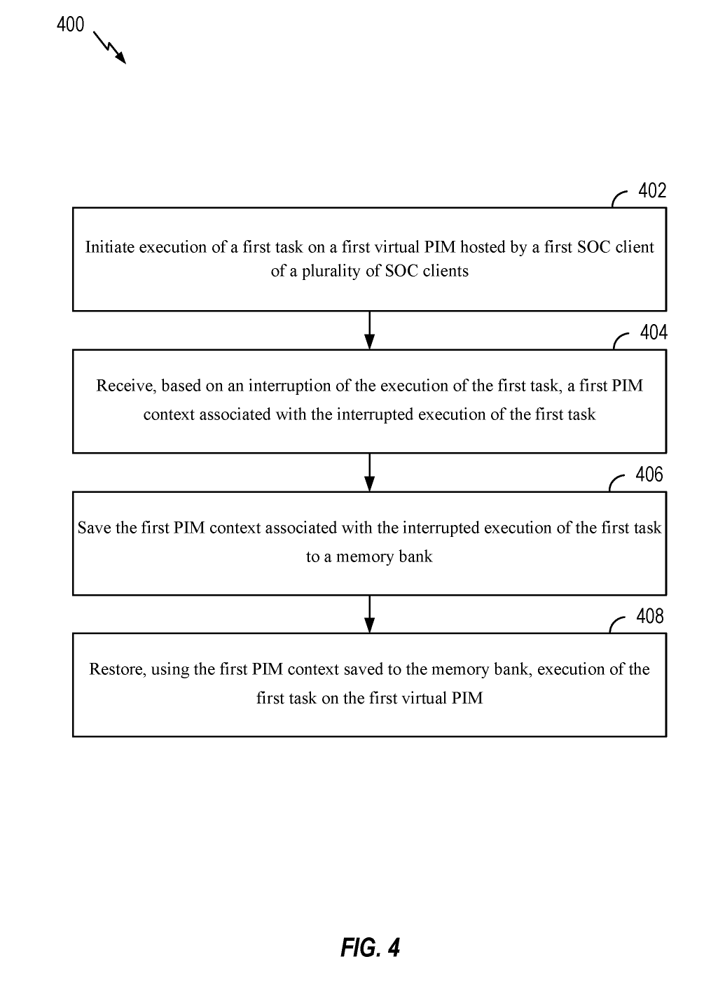

FIG. 4 shows a flow chart of an example process 400 performable by or at a memory controller of a PIM device for supporting and efficiently saving and restoring contexts according to one or more aspects of this disclosure. The memory controller of the PIM device can implement process 400 through various hardware and software components working together to support multiple contexts associated with multiple SoC clients, while maintaining computational efficiency and minimizing functional errors. For example, process 400 may be performed by the memory controller 106 of memory 108 of the PIM device. In some embodiments, the memory controller may be configured to perform one or more of the following blocks based on executable instructions stored in the memory (e.g., memory 108).

At block 402, the memory controller (e.g., memory controller 106) may initiate the execution of a task on a virtual PIM hosted by an SoC client of a plurality of SoC clients. The task in block 402, referred to in process 400 as the first task, may be one of a plurality of tasks associated with an application. Furthermore, tasks of the application may be assigned to the plurality of SoC clients as part of a heterogenous computing architecture involving various compute subsystems to perform various aspects of the application. For example, in some embodiments, the memory controller may have received the plurality of tasks including the first task prior to initiating the execution of the first task on the first virtual PIM. Furthermore, the memory controller may assign, for each task, an SoC client to execute the task on a respective virtual PIM hosted by the SoC client. In some embodiments, as the memory controller receives each task (e.g., as data packets containing instructions received via a communication network from an external device or server), the memory controller may save contexts associated with the task. For example, in some embodiments, the memory controller may store a plurality of PIM contexts respectively associated with the plurality of tasks in a memory bank (e.g., DRAM bank 202) of the PIM device.

At block 404, the memory controller (e.g., memory controller 106) may receive, based on an interruption of the execution of the first task, a first PIM context associated with the interrupted execution of the first task. For example, after initiating the execution of the first task on the first virtual PIM, the memory controller may interrupt or otherwise cause suspension of the execution of the first task. The suspension may be based on a context switching protocol for switching between tasks of the plurality of tasks. The context switching protocol is based on one or more of a plurality of factors, including but not limited to: a time associated with an execution of a task, of the plurality of tasks, exceeding a predetermined time threshold; or a size of data associated with the task exceeding a predetermined size threshold. Exceeding the threshold may prompt the memory controller to interrupt the task (e.g., the first task), in order to switch to a new task for execution. Additionally, or alternatively, the context switching protocol may be based on a priority of a task relative to the plurality of tasks and/or a priority of the SoC client assigned to the task, relative to the plurality of SoC clients. In some embodiments, the memory controller (e.g., memory controller 106) may read the first PIM context from one or more registers in the PIM device (e.g., one or more of accumulator 208, MAC unit 204, or vector 206).

At block 406, the memory controller (e.g., memory controller 106) may save the first PIM context associated with the interrupted execution of the first task to a memory bank (e.g., DRAM bank 202). For example, the memory controller may save the first PIM context in the memory bank after reading the first PIM context from one or more registers in the PIM device (e.g., one or more of accumulator 208, MAC unit 204, or vector 206). As previously discussed, the virtual PIMs of the SoC clients (e.g., virtual PIMs 304A-304C of SoC clients 302A-302C) may be mapped to the physical registers in the memory (e.g., registers 204, 206, and 208 if memory 108). Thus, based on entry of values for a PIM context in the virtual PIMs, accumulated values may result in the accumulator register (e.g., accumulator register 208). The memory controller may (e.g., after reading the values from the accumulator register for a specific context) store those values in a memory bank (e.g., DRAM bank 202) for the specific context.

In some embodiments, for example, where each SoC client is provided an assigned physical register or an assigned set of physical registers in the PIM device, saving the first PIM context may include storing the accumulated values associated with the first PIM context from the first virtual PIM to a physical register in the PIM device (e.g., accumulator register 208) assigned to the first SoC client.

In some embodiments, after receiving the first PIM context associated with the interrupted execution of the first task and prior to restoring the execution of the first task, the memory controller (e.g., memory controller 106) may initiate execution of another task (second task) on another virtual PIM (a second virtual PIM) hosted by another SoC client (a second SOC client) of the plurality of SOC clients. For example, as was previously described in relation to FIG. 3B, the memory controller 106 may suspend task 306A executed by the CPU 302A (see section 308 of FIG. 3B) before all values are loaded into the MAC units, save the context associated with the task (e.g., via the Save Ctxt1 command) and switch to initiating a different task 306B to be performed by the GPU 302B (see section 310 of FIG. 3B). The second task may be executed completed or may also be suspended to return to the first task (as shown in FIG. 4) or may switch to yet another task, depending on the context switching protocol.

At block 408, the memory controller (e.g., memory controller 106) may restore, using the first PIM context saved to the memory bank, execution of the first task on the first virtual PIM. For example, based on a command (e.g., Restore Ctxt1 as previously described in relation to FIG. 3B), the memory controller may retrieve, from a memory bank such as but not limited to DRAM bank 202, the context data stored for the first task. The context data may include the set of values read from the register during the saving of the first task. For example, the context data may include accumulator values obtained from the accumulator register (e.g., accumulator register 208) when the context was saved and/or may include accumulated values from matrix vector computation obtained via the first virtual PIM during the saving of the context. The restoring of the context may include loading the context values to one or more registers of the virtual PIM, thereby allowing the first SoC client to resume operations of the first task from where it left off. For example, if the first task was suspended at a point where a portion but not all of vector values were loaded on to one or more MAC units (e.g., via LdMAC operations as shown and described in relation to FIG. 3B), the context data may enable the first SoC client to resume operations by loading the next set of vector values on to the one or more MAC units (e.g., MAC unit 204 or a corresponding virtualized MAC unit in the virtual PIM) to resume operation of the first task. Thus, by saving the first PIM context associated with the first task (e.g., at block 404), and using the saved first PIM context to restore the first task (e.g., at block 408), the memory controller may allow a plurality of SoC clients to perform tasks of a heterogenous application in a manner that reduces bottlenecks and inefficiencies caused by any one task.

In some embodiments, for example, where each SoC client is assigned with one or more physical registers in the PIM device, restoring the execution of the first task using the saved first PIM context may include retrieving, from the one or more assigned physical registers (e.g., accumulator register 208), saved values associated with the first virtual PIM, and reloading the saved values to the first virtual PIM to allow the first SoC client to resume execution of the first task.

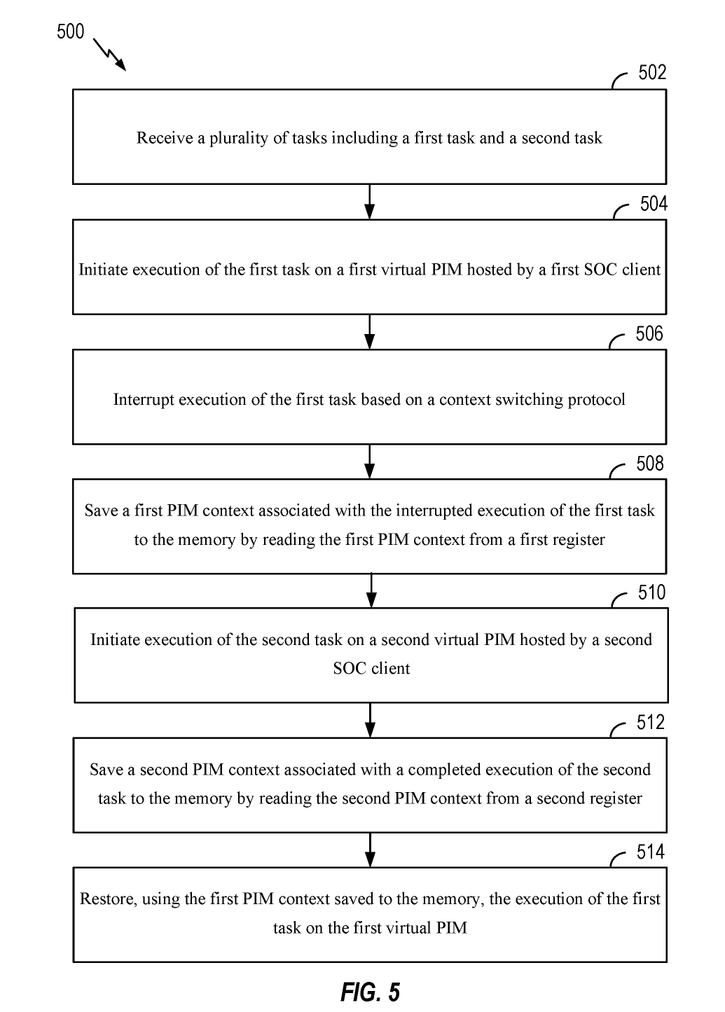

FIG. 5 shows a flow chart of an example process 500 performable by or at a memory controller of a PIM device for supporting and efficiently switching between multiple contexts associated with multiple SoC clients according to one or more aspects of this disclosure. The memory controller of the PIM device can implement process 500 through various hardware and software components working together to interleave multiple contexts and tasks associated with the multiple SoC clients while maintaining computational efficiency and minimizing functional errors. For example, process 500 may be performed by the memory controller 106 of the memory 108 of the PIM device. In some embodiments, the memory controller may be configured to perform one or more of the following blocks based on executable instructions stored in the memory (e.g., memory 108).

As previously discussed, the PIM device may be used for the implementation of an application involving heterogenous computing (heterogenous application), such as an AI application, in a PIM architecture. In a heterogenous application, tasks for the application are distributed over multiple SoC clients (e.g., computing cores and/or subsystems), such as but not limited to a CPU, a GPU, or an NSP, as part of one or more SoCs. In a PIM architecture, computational units such as a set of registers and a controller (e.g., memory controller) may be integrated within memory devices to enable matrix-vector operations to be performed directly within the memory device, and therefore leverage higher memory bandwidth. The memory controller and/or the PIM device may thus utilize the benefits of heterogenous application architecture and PIM architecture by assigning each of a plurality tasks for the heterogenous application to a respective SoC client that may be suited for the task, while utilizing the hardware resources of the PIM device.

Thus, the example process 500 may begin or include, at block 502, the memory controller (e.g., memory controller 106) receiving a plurality of tasks (e.g., for a heterogenous application). The plurality of tasks may include a first task and a second task. Each task may be assigned to respective SoC client as previously discussed. For example, the first task may be assigned to the first SoC client and the second task may be assigned to the second SoC client. In some embodiments, if tasks are labeled or otherwise configured to be performed by a specific SoC client, the tasks may be sent to and received by that SoC client for processing. Also or alternatively, SoC clients may be assigned tasks based on availability.

At block 504, the memory controller (e.g., memory controller 106) may initiate execution of the first task on a first virtual PIM hosted by a first SOC client. As previously discussed, the limited hardware resources of the PIM architecture, which may in some embodiments include a single set of registers (e.g., vector register 206, MAC unit 204, and accumulator register 208), may make heterogenous applications difficult to implement in a PIM architecture. The techniques described herein may overcome this issue by having each of the SoC client host a virtual PIM to perform processing associated with the tasks of the application, thus freeing up the physical hardware of the PIM device. Thus, the first task may be performed by the first SoC client using a virtual PIM (first virtual PIM) hosted by the SoC client to execute the first task. For example, the first SoC may begin loading vector register values into one or more MAC units (e.g., via load MAC operations (e.g., LdMAC1, LdMAC2, …”)) as previously described and shown in relation to FIG. 3B via the first virtual PIM. In some embodiments, values stored in one or more virtual registers of the first virtual PIM may be used to synchronize with or to store values in one or more physical registers in the PIM device, for example, when a physical register in the PIM device is available for storage of values associated with a new task and/or at periodic intervals.

At block 506, the memory controller (e.g., memory controller 106) may interrupt (or otherwise suspend) the execution of the first task based on a context switching protocol. The suspension may be based on a context switching protocol for switching between tasks of the plurality of tasks. The context switching protocol is based on one or more of a plurality of factors, including but not limited to: a time associated with an execution of a task, of the plurality of tasks, exceeding a predetermined time threshold; or a size of data associated with the task exceeding a predetermined size threshold. Exceeding the threshold may prompt the memory controller to interrupt the task (e.g., the first task), in order to switch to a new task for execution. Additionally, or alternatively, the context switching protocol may be based on a priority of a task relative to the plurality of tasks and/or a priority of the SOC client assigned to the task, relative to the plurality of SOC clients. In some embodiments, the context switching protocol may be received by the PIM device, or may be programmed into the PIM device. Additionally, or alternatively, the PIM device may determine a context switching protocol based on parameters associated with the SoC clients, the received tasks, and/or an application (e.g., estimate of time to perform tasks, processing constraints of the SoC clients, estimate of data associated with each task, etc.).

At block 508, the memory controller (e.g., memory controller 106) may save a first PIM context associated with the interrupted execution of the first task to the memory. For example, the memory controller may save the first PIM context in the memory bank by reading the first PIM context from at least one register (first register) in the PIM device. As previously discussed, the virtual PIMs of the SoC clients (e.g., virtual PIMs 304A-304C of SoC clients 302A-302C, respectively) may be mapped to the physical registers in the memory (e.g., vector register 206, MAC unit 204, and accumulator register 208 of memory 108). Thus, based on entry of values for a PIM context in the virtual PIMs (e.g., virtual PIMs 304A-304C), accumulated values may result in the accumulator register (e.g., accumulator register 208). The memory controller may read the values from the accumulator register for a specific context and may store those values in a memory bank (e.g., DRAM bank 202) for the specific context. Additionally, or alternatively, in embodiments where each SoC client is provided an assigned register or set of physical register in the PIM device, saving the first PIM context may include storing the accumulated values from the first virtual PIM associated with the first PIM context to a physical register in the PIM device (e.g., an accumulator register) assigned to the first SoC client.

At block 510, the memory controller (e.g., memory controller 106) may initiate execution of the second task on a virtual PIM (second virtual PIM) hosted by another SoC client (second SoC client). For example, the second SoC may begin loading vector register values into one or more MAC units (e.g., via load MAC operations (e.g., LdMAC1, LdMAC2, …”)) as previously described and shown in relation to FIG. 3B via the second virtual PIM. In some embodiments, values stored in virtual registers in the virtual PIM may be used to synchronize or store values in the physical registers in the PIM device (e.g., when the physical registers in the PIM device is available and/or at periodic intervals). The execution of the second task may be completed or may also be suspended to return to the first task (as shown in FIG. 5) or to switch to yet another task, depending on the context switching protocol.

At block 512, the memory controller (e.g., memory controller 106) may save a second PIM context associated with a completed execution of the second task to the memory by reading the second PIM context from a second register. As previously discussed in relation to block 508, the memory controller may save the second PIM context in the memory bank by reading the second PIM context from at least one register (second register) in the PIM device, and then saving the read values to the memory bank (e.g., DRAM bank 202). As previously discussed, the virtual PIMs of the SoC clients may be mapped to the physical registers in the memory. Thus, based on entry of values for a PIM context in the virtual PIMs, accumulated values from virtual registers in the virtual PIM may result in being placed in the physical register (e.g., accumulator register) of the PIM device. The memory controller may read the values from the accumulator register for a specific context and may store those values in a memory bank (e.g., DRAM bank 202) for the specific context. Additionally, or alternatively, in embodiments where each SoC client is provided an assigned register or set of physical register in the PIM device, saving the first PIM context may include storing the accumulated values from the first virtual PIM associated with the first PIM context to a physical register in the PIM device (e.g., an accumulator register) assigned to the first SoC client.

At block 514, the memory controller (e.g., memory controller 106) may restore, using the first PIM context saved to the memory, the execution of the first task on the first virtual PIM. For example, the memory controller may retrieve, from a memory bank (e.g., DRAM 202) and/or an assigned physical register for the first SoC client, the context data stored for the first task. The context data may include the set of values read from the register during the saving of the first task. For example, the context data may include accumulator values obtained from the accumulator register when the context was saved and/or may include accumulated values from matrix vector computation obtained via the first virtual PIM during the saving of the context. The restoring of the context may include loading the context values to one or more registers thereby allowing the first SoC client to resume operations of the first task from where it left off. For example, if the first task was suspended at a point where a portion but not all of vector values were loaded on to one or more MAC units (e.g., via LdMAC operations as shown and described in relation to FIG. 3B), the context data may enable the first SoC client to resume operations by loading the next set of vector values on to the one or more MAC units to resume operation of the first task.

In some embodiments, for example, where each SoC client is assigned with one or more physical registers in the PIM device, restoring the execution of the first task using the saved first PIM context may include retrieving, from the one or more assigned physical registers, saved values associated with the first virtual PIM associated, and reloading the saved values to the first virtual PIM to allow the first SoC client to resume execution of the first task.

Thus, the memory controller (e.g., memory controller 106) may efficiently interleave different tasks of a heterogenous application performed by different SoC clients (e.g., SoC clients 302A-302C) in a manner by relying on its ability to save contexts from virtual PIMs (e.g., virtual PIMs 304A-304C) and restore contexts, and interrupt tasks based on a context switching protocol.

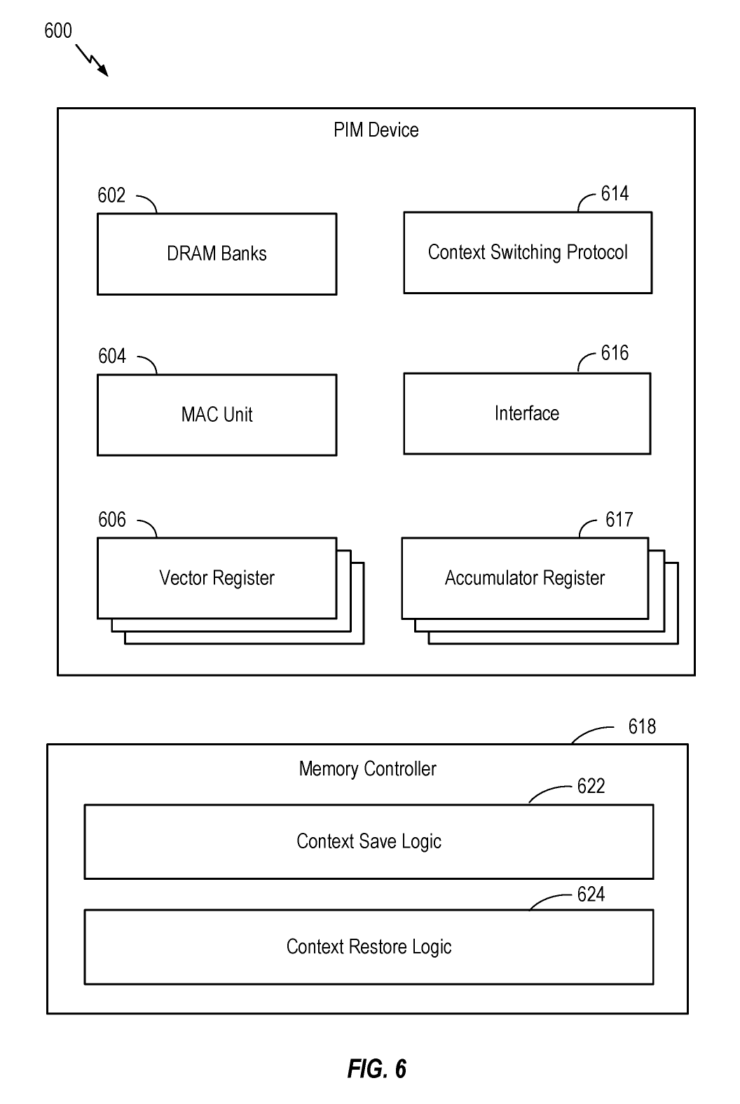

FIG. 6 illustrates a block diagram of a processing-in-memory (PIM) device 600 configured to perform one or more aforementioned techniques or processes (e.g., processes 400 and 500) according to one or more aspects of this disclosure. For example, the PIM device 600 may be configured to support and efficiently switch between multiple contexts associated with multiple SoC clients according to one or more aspects of this disclosure.

PIM device 600 includes one or more DRAM banks 602 (such as, for example, DRAM bank 202) configured to store weight matrices and input vectors. Each DRAM bank 602 couples to a MAC unit 604 (such as, for example, MAC unit 204) through a data bus that enables transfer of matrix portions and vector data. MAC unit 604 performs matrix-vector multiplication operations on data retrieved from DRAM bank 602.

PIM device 600 includes one or more vector registers 606 (such as, for example, vector register 206) configured to store input vectors during processing. One or more accumulator registers 617 (such as, for example, accumulator register 208) couples to MAC unit 604 through a dedicated path and accumulates results from matrix-vector operations. When implemented to support different bit-widths, MAC unit 604 includes circuitry configured to process weight values of a first bit-width (e.g., 4 bits) and input vector values of a second bit-width (e.g., 8 bits).

The memory controller 618 (such as, for example, memory controller 106) coordinates operations across device 600 through a control bus. The memory controller 618 may include a context save logic 622 that can save contexts associated with tasks executed, interrupted, and/or suspended by SoC clients. For example, the memory controller 618 may interface with virtual PIMs hosted by the SoC clients to determine values stored in various virtual registers to determine accumulated values to store in a register (e.g., accumulator register 617) and/or a DRAM bank 602. Additionally, or alternatively, the memory controller 618 may store a copy of contents of the accumulator register 617 assigned to an SoC client for which the context is being saved. The accumulator register 617 may be mapped to the virtual PIM of the SoC client. The memory controller 618 may further include a context restore logic 624 that can restore contexts and/or tasks associated with the contexts. In some embodiments, the context restore logic 624 can restore tasks associated with the contexts on virtual PIMs of SoC clients assigned to those tasks. For example, the memory controller 618 may retrieve a context for restoration from a context bank (e.g., as stored in DRAM banks 602) and/or the accumulator register 617. The memory controller 618 may be prompted to do so based on a context switching protocol (e.g., to switch back to a task that had previously been interrupted or suspended) and/or based on a command (e.g., Restore Ctxt1 as previously shown in FIG. 3B).

In some embodiments, the memory controller 618 may be located within the SoC clients and may interface with the PIM device 600 to orchestrate the PIM context switches as described herein. For example, as shown in FIG. 6, the memory controller 618 may be separate from the PIM device 600. In another embodiment, the memory controller 618 may be a part of a PIM device.

In some embodiments, the PIM device 600 may receive and/or store a context switching protocol 614. The context switching protocol 614 may include executable instructions or rules for switching between tasks, contexts, and/or associated SoC clients. In some aspects, the context switching protocol 614 may be a command to switch to a higher priority task or context and may be prompted by the PIM device 600 or memory controller 618 receiving the higher priority task (e.g., from an external device). In some embodiments, the context switching protocol 614 may be based on, for example, a time associated with an execution of a task exceeding a predetermined time threshold, a size of data associated with the task exceeding a predetermined size threshold, a priority of a task relative to other tasks, or a priority of the SOC client assigned to the task, relative to other SOC clients.

In some embodiments, the PIM device 600 may further include an interface unit 616 that enables communication with external devices and/or processors. For example, in some embodiments, one or more SoC clients may be located on an SoC that is remote from the PIM device 600. The memory controller 618 may interface with such remote SoC clients via the interface unit 616.

In operation, PIM device 600 performs process 400 by having the memory controller 618 initiate execution of a task (first task) on a virtual PIM (first virtual PIM) hosted by an SoC client (first SoC client) of a plurality of SoC clients associated with the PIM device 600 (block 402). MAC unit 604 performs matrix-vector operations with results accumulating in accumulator 617 for commands associated with the first task. If the first task is interrupted, the memory controller 618 may receive a first PIM context associated with the interrupted execution of the first task (block 404). The memory controller 618 may receive the first PIM context by determining or reading the contents of the accumulator register 617. The contents of the accumulator register may be based on values accumulated based on computations performed for the first task in the virtual PIM of the first SoC client. The memory controller 618 may save the first PIM context associated with the interrupted execution of the first task to the PIM device for example in the DRAM banks 602 (block 406). Additionally, or alternatively, in embodiments where each SoC client is also assigned one or more physical registers, the memory controller may save PIM contexts by retrieving accumulated context values from the virtual PIM associated with the SoC client and then saving the retrieved values in the accumulator register 617 assigned to the SoC client. The interruption of the first task and a subsequent switch to another task (second task) assigned to another SoC client (second SoC client) may be based on the context switching protocol 614. Furthermore, the memory controller 618 may restore execution of the first task on the first virtual PIM using the first PIM context.

In operation, PIM device 600 performs process 500 by having the memory controller 618 receive tasks associated an application, for which contexts associated with the tasks can be stored in context banks in the DRAM banks 602. Furthermore, the PIM device 600 can initiate execution of tasks, such as the first task or the second task, on virtual PIMs (first virtual PIM or second virtual PIM, respectively) hosted by SoC clients (first SoC client or second SoC client, respectively) of a plurality of SoC clients associated with the PIM device 600 (blocks 504 and 510, respectively). MAC unit 604 performs matrix-vector operations with results accumulating in the one or more accumulators 617 for commands associated with such tasks. If a task (e.g., the first task) is interrupted, the memory controller 618 may receive a PIM context associated with the interrupted execution of the task (block 404). The memory controller 618 may interrupt an execution of the first task based on the context switching protocol 614 (block 506). The memory controller 618 may receive the PIM context by determining or reading the contents of the one or more accumulator registers 617. The contents of the accumulator register may be based on values accumulated based on computations performed for the task in the virtual PIM of the respective SoC client. The memory controller 618 may save PIM contexts (e.g., the first PIM context or second PIM context) associated with the interrupted executions of the tasks (first task or second task) to the PIM device for example in the DRAM banks 602 (blocks 508 and 512, respectively). Additionally, or alternatively, in embodiments where each SoC client is also assigned one or more physical registers, the memory controller may save PIM contexts by retrieving accumulated context values from the virtual PIM associated with the SoC client and then saving the retrieved values in the one or more accumulator registers 617 assigned to the SoC client. The interruption of tasks and subsequent switching to another task assigned to another SoC client may be based on the context switching protocol 614. Furthermore, the memory controller 618 may restore execution of the first task on the first virtual PIM using the first PIM context.

It should be appreciated that device 600 includes means for performing steps to execute processes 400 and 500. In one implementation, device 600 includes means for saving, the first PIM context associated with the interrupted execution of the first task to one or more registers in the PIM device. The device 600 further includes means for restoring, using the saved first PIM context, execution of the first task on the first virtual PIM. Means for saving the context is performed by context save logic 622 executing with memory controller 618. Furthermore, means for restoring the context on the virtual PIM is performed by context restore logic 622 executing with memory controller 618.

In one or more aspects, techniques for supporting and efficiently switching between multiple contexts associated with multiple SoC clients in a PIM device may include additional aspects, such as any single aspect or any combination of aspects described below or in connection with one or more other processes described elsewhere herein. Additionally, an apparatus may perform or operate according to one or more aspects as described below. In some implementations, the apparatus includes a processing-in-memory device. In some implementations, the apparatus includes at least one processor and a memory coupled to the processor. The processor may be configured to perform operations described herein with respect to the apparatus. In some other implementations, the apparatus may include a non-transitory computer-readable medium having program code recorded thereon, the program code being executable by a computer for causing the computer to perform operations described herein. In some implementations, the apparatus may include one or more means configured to perform operations described herein.

In a first aspect, a method of supporting multiple contexts in a processing-in-memory (PIM) device associated with a plurality of system on a chip (SoC) clients includes: initiating, by a memory controller of the PIM device, execution of a first task on a first virtual PIM hosted by a first SoC client of the plurality of SoC clients; receiving, by the memory controller based on an interruption of the execution of the first task, a first PIM context associated with the interrupted execution of the first task; saving, by the memory controller, the first PIM context associated with the interrupted execution of the first task to a memory bank of the PIM device; and restoring, by the memory controller using the first PIM context saved to the memory bank, execution of the first task on the first virtual PIM.

In a second aspect, in combination with the first aspect, the method further includes, after receiving the first PIM context associated with the interrupted execution of the first task and prior to restoring the execution of the first task: initiating, by the memory controller, execution of a second task on a second virtual PIM hosted by a second SoC client of the plurality of SoC clients.

In a third aspect, in combination with one or more of the first aspect through the second aspect, the method further includes, prior to initiating the execution of the first task on the first virtual PIM: receiving, by the memory controller, a plurality of tasks including the first task; and assigning, for each task, an SoC client to execute the task on a respective virtual PIM hosted by the SoC client.

In a fourth aspect, in combination with one or more of the first aspect through the third aspect, the method further includes: storing a plurality of PIM contexts respectively associated with the plurality of tasks in the memory bank of the PIM device.

In a fifth aspect, in combination with one or more of the first aspect through the fourth aspect, the method further includes, after initiating the execution of the first task on the first virtual PIM: interrupting, by the memory controller, the execution of the first task based on a context switching protocol for switching between tasks of the plurality of tasks.

In a sixth aspect, in combination with one or more of the first aspect through the fifth aspect, the context switching protocol is based on one or more of: a time associated with an execution of a task, of the plurality of tasks, exceeding a predetermined time threshold; or a size of data associated with the task exceeding a predetermined size threshold.

In a seventh aspect, in combination with one or more of the first aspect through the sixth aspect, the context switching protocol is based on one or more of: a priority of a task relative to the plurality of tasks; or a priority of the SoC client assigned to the task, relative to the plurality of SoC clients.

In an eighth aspect, in combination with one or more of the first aspect through the seventh aspect, receiving the first PIM context includes reading the first PIM context from one or more registers in the PIM device.

In a ninth aspect, in combination with one or more of the first aspect through the eighth aspect, the one or more registers in the PIM device includes a vector register and an accumulator register.

In a tenth aspect, an apparatus for supporting multiple contexts using a processing-in-memory (PIM) device is disclosed. The apparatus includes: a memory comprising one or more registers and configured to store PIM contexts; and a memory controller coupled to the memory. The memory controller is configured to perform operations including: initiating execution of a first task on a first virtual PIM hosted by a first SoC client of the plurality of SoC clients; receiving, based on an interruption of the execution of the first task, a first PIM context associated with the interrupted execution of the first task; saving the first PIM context associated with the interrupted execution of the first task to a memory bank of the PIM device; and restoring, using the first PIM context saved to the memory bank, execution of the first task on the first virtual PIM.

In an eleventh aspect, in combination with the tenth aspect, after receiving the first PIM context associated with the interrupted execution of the first task and prior to restoring the execution of the first task, the memory controller is configured to perform operations further including: initiating execution of a second task on a second virtual PIM hosted by a second SoC client of the plurality of SoC clients.

In a twelfth aspect, in combination with one or more of the tenth aspect through the eleventh aspect, prior to initiating the execution of the first task on the first virtual PIM, the memory controller is configured to perform operations further including: receiving a plurality of tasks including the first task; and assigning, for each task, an SoC client to execute the task on a respective virtual PIM hosted by the SoC client.

In a thirteenth aspect, in combination with one or more of the tenth aspect through the twelfth aspect, the memory controller is configured to perform operations further including: storing a plurality of PIM contexts respectively associated with the plurality of tasks in the memory bank of the PIM device.

In a fourteenth aspect, in combination with one or more of the tenth aspect through the thirteenth aspect, after initiating the execution of the first task on the first virtual PIM, the memory controller is configured to perform operations further including: interrupting, by the memory controller, the execution of the first task based on a context switching protocol for switching between tasks of the plurality of tasks.

In a fifteenth aspect, in combination with one or more of the tenth aspect through the fourteenth aspect, the context switching protocol is based on one or more of: a time associated with an execution of a task, of the plurality of tasks, exceeding a predetermined time threshold; or a size of data associated with the task exceeding a predetermined size threshold.

In a sixteenth aspect, in combination with one or more of the tenth aspect through the fifteenth aspect, the context switching protocol is based on one or more of: a priority of a task relative to the plurality of tasks; or a priority of the SoC client assigned to the task, relative to the plurality of SoC clients.

In a seventeenth aspect, in combination with one or more of the tenth aspect through the sixteenth aspect, the memory controller is configured to receive the first PIM context by reading the first PIM context from one or more registers in the PIM device.

In an eighteenth aspect, in combination with one or more of the tenth aspect through the seventeenth aspect, the one or more registers in the PIM device includes a vector register and an accumulator register.

In a nineteenth aspect, a system for supporting multiple contexts in a processing-in-memory (PIM) device is disclosed. The system includes: a plurality of system on a chip (SoC) clients, wherein each SoC client is configured to host a respective virtual PIM, wherein the plurality of SoC clients includes at least a first SoC client hosting a first virtual PIM and a second SoC client hosting a second virtual PIM; a memory comprising one or more registers and configured to store PIM contexts; and a memory controller coupled to the memory. The memory controller is configured to perform operations including: receiving a plurality of tasks including a first task and a second task; initiating execution of the first task on the first virtual PIM; interrupting the execution of the first task based on a context switching protocol for switching between tasks of the plurality of tasks; saving a first PIM context associated with the interrupted execution of the first task to the memory by reading the first PIM context from a first register of the one or more registers; initiating execution of the second task on the second virtual PIM; saving a second PIM context associated with a completed execution of the second task to the memory by reading the second PIM context from a second register of the one or more registers; and restoring, using the first PIM context saved to the memory, the execution of the first task on the first virtual PIM.

In a twentieth aspect, in combination with the nineteenth aspect, the context switching protocol is based on one or more of: a time associated with an execution of a task, of the plurality of tasks, exceeding a predetermined time threshold; a size of data associated with the task exceeding a predetermined size threshold; a priority of a task relative to the plurality of tasks; or a priority of the SoC client assigned to the task, relative to the plurality of SoC clients.

In a twenty first aspect, an apparatus for supporting multiple contexts using a processing-in-memory (PIM) device is disclosed. The apparatus includes: a means for storing PIM contexts; a means for initiating execution of a first task on a first virtual PIM hosted by a first SoC client of the plurality of SoC clients; a means for receiving, based on an interruption of the execution of the first task, a first PIM context associated with the interrupted execution of the first task; a means for saving the first PIM context associated with the interrupted execution of the first task to a memory bank of the PIM device; and a means for restoring, using the first PIM context saved to the memory bank, execution of the first task on the first virtual PIM.

In a twenty-second aspect, an apparatus for supporting multiple contexts using the PIM device in combination with the twenty-first aspect is disclosed, which further comprises means for performing any of the second to ninth aspects.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it should be appreciated that throughout this disclosure, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system’s registers and memories into other data similarly represented as physical quantities within the computer system’s registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as, e.g., “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for supporting multiple contexts in a processing-in-memory (PIM) device associated with a plurality of system on a chip (SoC) clients, the method comprising:
initiating, by a memory controller of the PIM device, execution of a first task on a first virtual PIM hosted by a first SoC client of the plurality of SoC clients;
receiving, by the memory controller based on an interruption of the execution of the first task, a first PIM context associated with the interrupted execution of the first task;
saving, by the memory controller, the first PIM context associated with the interrupted execution of the first task to a memory bank of the PIM device; and
restoring, by the memory controller using the first PIM context saved to the memory bank, execution of the first task on the first virtual PIM.

2. The method of claim 1, further comprising, after receiving the first PIM context associated with the interrupted execution of the first task and prior to restoring the execution of the first task,
initiating, by the memory controller, execution of a second task on a second virtual PIM hosted by a second SoC client of the plurality of SoC clients.

3. The method of claim 1, further comprising, prior to initiating the execution of the first task on the first virtual PIM:
receiving, by the memory controller, a plurality of tasks including the first task; and
assigning, for each task, an SoC client to execute the task on a respective virtual PIM hosted by the SoC client.

4. The method of claim 3, further comprising:
storing a plurality of PIM contexts respectively associated with the plurality of tasks in the memory bank of the PIM device.

5. The method of claim 3, further comprising, after initiating the execution of the first task on the first virtual PIM:
interrupting, by the memory controller, the execution of the first task based on a context switching protocol for switching between tasks of the plurality of tasks.

6. The method of claim 5, wherein the context switching protocol is based on one or more of:
a time associated with an execution of a task, of the plurality of tasks, exceeding a predetermined time threshold; or
a size of data associated with the task exceeding a predetermined size threshold.

7. The method of claim 5, wherein the context switching protocol is based on one or more of:
a priority of a task relative to the plurality of tasks; or
a priority of the SoC client assigned to the task, relative to the plurality of SoC clients.

8. The method of claim 1, wherein receiving the first PIM context comprises reading the first PIM context from one or more registers in the PIM device.

9. The method of claim 8, wherein the one or more registers in the PIM device comprises a vector register and an accumulator register.

10. An apparatus for supporting multiple contexts using a processing-in-memory (PIM) device, the apparatus comprising:
a memory comprising one or more registers and configured to store PIM contexts; and
a memory controller coupled to the memory, and configured to perform operations, the operations comprising:
initiating execution of a first task on a first virtual PIM hosted by a first SoC client of a plurality of SoC clients;
receiving, based on an interruption of the execution of the first task, a first PIM context associated with the interrupted execution of the first task;
saving the first PIM context associated with the interrupted execution of the first task to the memory; and
restoring, using the first PIM context saved to the memory, execution of the first task on the first virtual PIM.

11. The apparatus of claim 10, wherein, after receiving the first PIM context associated with the interrupted execution of the first task and prior to restoring the execution of the first task, the memory controller is configured to perform operations further comprising:
initiating, by the memory controller, execution of a second task on a second virtual PIM hosted by a second SoC client of the plurality of SoC clients.

12. The apparatus of claim 10, wherein, prior to initiating the execution of the first task on the first virtual PIM, the memory controller is configured to perform operations further comprising:
receiving, by the memory controller, a plurality of tasks including the first task; and
assigning, for each task, an SoC client to execute the task on a respective virtual PIM hosted by the SoC client.

13. The apparatus of claim 12, wherein the memory controller is configured to perform operations further comprising:
storing a plurality of PIM contexts respectively associated with the plurality of tasks in the memory of the PIM device.

14. The apparatus of claim 12, wherein, after initiating the execution of the first task on the first virtual PIM, the memory controller is configured to perform operations further comprising:
interrupting, by the memory controller, the execution of the first task based on a context switching protocol for switching between tasks of the plurality of tasks.

15. The apparatus of claim 14, wherein the context switching protocol is based on one or more of:
a time associated with an execution of a task, of the plurality of tasks, exceeding a predetermined time threshold; or
a size of data associated with the task exceeding a predetermined size threshold.

16. The apparatus of claim 14, wherein the context switching protocol is based on one or more of:
a priority of a task relative to the plurality of tasks; or
a priority of the SoC client assigned to the task, relative to the plurality of SoC clients.

17. The apparatus of claim 10, further comprising one or more registers, wherein the memory controller is configured to receive the first PIM context by reading the first PIM context from one or more registers in the PIM device.

18. The apparatus of claim 17, wherein the one or more registers in the PIM device comprises a vector register and an accumulator register.

19. A system for supporting multiple contexts in a processing-in memory (PIM) device, the system comprising:
a plurality of system on a chip (SoC) clients, wherein each SoC client is configured to host a respective virtual PIM, wherein the plurality of SoC clients includes at least a first SoC client hosting a first virtual PIM and a second SoC client hosting a second virtual PIM;
a memory comprising one or more registers and configured to store PIM contexts; and
a memory controller coupled to the memory, and configured to perform operations comprising:
receiving a plurality of tasks including a first task and a second task;
initiating execution of the first task on the first virtual PIM;
interrupting the execution of the first task based on a context switching protocol for switching between tasks of the plurality of tasks;
saving a first PIM context associated with the interrupted execution of the first task to the memory by reading the first PIM context from a first register of the one or more registers;
initiating execution of the second task on the second virtual PIM;
saving a second PIM context associated with a completed execution of the second task to the memory by reading the second PIM context from a second register of the one or more registers; and
restoring, using the first PIM context saved to the memory, the execution of the first task on the first virtual PIM.

20. The system of claim 19, wherein the context switching protocol is based on one or more of:
a time associated with an execution of a task, of the plurality of tasks, exceeding a predetermined time threshold;
a size of data associated with the task exceeding a predetermined size threshold;
a priority of a task relative to the plurality of tasks; or
a priority of the SoC client assigned to the task, relative to the plurality of SoC clients.
